(19) United States
(12) Patent Application Publication
(10) Pub. No.: US 2026/0094883 A1
(43) Pub. Date: Apr. 2, 2026

(54) BATTERY MANAGEMENT SYSTEM HAVING A PLURALITY OF BACKUP COMMUNICATION MAIN UNITS, AND AIRCRAFT

(71) Applicant: EHANG INTELLIGENT EQUIPMENT (GUANGZHOU) CO., LTD., Guangzhou (CN)

(72) Inventors: Huazhi HU, Guangzhou (CN); Kenzhen CHEN, Guangzhou (CN)

(73) Assignee: EHANG INTELLIGENT EQUIPMENT (GUANGZHOU) CO., LTD., Guangzhou (CN)

(21) Appl. No.: 19/110,440

(22) PCT Filed: Sep. 7, 2023
(86) PCT No.: PCT/CN2023/117535

§ 371 Date: Mar. 11, 2025

(30) Foreign Application Priority Data
Sep. 15, 2022 (CN) 202211130551.0

(51) Int. Cl. H01M 10/42; H01M 10/48; H01M 50/222; H01M 50/242; H01M 50/249; H01M 50/583

(52) U.S. Cl. CPC H01M 10/425; H01M 10/482; H01M 10/486; H01M 50/222; H01M 50/242; H01M 50/249; H01M 50/583; H01M 2010/4271; H01M 2010/4278; H01M 2220/20

(57) ABSTRACT

A battery management system having a plurality of backup communication main units, and an aircraft are provided. In the battery management system, a plurality of independent power battery assemblies are provided, and the design of using a plurality of backup communication main units is used; and considering the hardware failure probability and the redundancy margin, some of all battery management units are selected as backup communication main units, thereby improving the fault tolerance rate and reliability of aircraft communication, ensuring that the aircraft reliably acquires battery data required by safe flight, improving the reliability of aircraft power supply management, and guaranteeing the flight safety of the aircraft.

### CROSS-REFERENCE TO THE RELATED APPLICATIONS

This application is the national phase entry of International Application No. PCT/CN2023/117535, filed on Sep. 7, 2023, which is based upon and claims priority to Chinese Patent Application No. 202211130551.0, filed on Sep. 15, 2022, the entire contents of which are incorporated herein by reference.

### TECHNICAL FIELD

The present invention pertains to the field of unmanned aerial vehicles, and more particularly to a battery management system with a plurality of backup communication main units and an aircraft.

### BACKGROUND

Existing electric multi-rotor aircrafts generally have only one battery or multiple batteries, which are connected in series or parallel to form a battery pack that serves as the power source for flight.

When multiple batteries are connected in series to form a battery pack, if any one of the batteries experiences a short-circuit fault, the entire battery pack will cease to supply power, causing the entire aircraft to lose propulsion and be unable to fly normally. In more severe cases, this could instantaneously trigger a fire, leading to the aircraft burning and crashing. However, connecting multiple batteries in parallel can prevent the aircraft from losing power due to a fault in a single battery. For example, as disclosed in the prior art, a power management system and aircraft for a multi-rotor manned aircraft improve the redundancy of the electric aircraft's power supply by using multiple battery units connected in parallel for power supply. These battery units also have circuit protection functions. When a fault occurs in one battery unit, it is controlled to disconnect that battery unit, while the other battery units continue to supply power to the aircraft. However, in such electric multi-rotor aircraft, the power management unit often has only one communication main unit for data communication with the flight control system. If this power management unit fails, it will result in the loss of data on battery charge, temperature, current, and other status information, which can significantly affect the flight safety of the aircraft.

### SUMMARY

To solve the issue of poor communication reliability in current aircraft battery management systems, this invention proposes a battery management system and aircraft with a plurality of backup communication main units, enhancing the fault tolerance and reliability of communication system, and ensuring that the aircraft reliably acquires the battery data required for safe flight.

To achieve the aforementioned technical effects, a technical solution of the invention is as follows:
A battery management system having a plurality of backup communication main units includes N sets of power battery modules connected in parallel. The N sets of power battery modules includes N battery management units in total. Among these N battery management units, M battery management units serve as backup communication main units, where M<N, and each backup communication main unit is capable of forwarding the data from the N sets of power battery modules connected in parallel to a complete ALLCAN network.

The battery management system having a plurality of backup communication main units proposed by the technical solution features multiple independent power battery modules, adopts a design with multiple backup communication main units, and considers the probability of hardware failure and redundancy margin. By selecting some battery management units as backup communication main units from all battery management units, the battery management system improves the fault tolerance and reliability of aircraft communication, ensures that the aircraft reliably acquires the battery data required for safe flight, enhances the reliability of aircraft power management, and ensures flight safety.

Preferably, each power battery module includes a battery management unit, a battery protection component, and a power battery pack. The battery protection component includes a fuse (FU), a Hall current sensor (H), and a relay (K). Within each power battery module, a negative terminal of the power battery pack is connected to a positive busbar of the aircraft, and a positive terminal of the power battery pack is connected to one end of the fuse (FU). The other end of the fuse (FU) passes through a central hole of the Hall current sensor (H) and is connected to a first contact of the relay (K), while a second contact of the relay (K) is connected to a negative busbar of the aircraft. A signal acquisition line of the Hall current sensor (H) is connected to the battery management unit to enable real-time current detection. A coil terminal of the relay (K) is connected to the battery management unit. The battery management unit controls the connection and disconnection of the coil terminal of the relay (K) based on received Controller Area Network (CAN) communication commands, thereby controlling whether the power battery module participates in the aircraft's charging and discharging state.

Here the battery protection component included in the power battery module is allowed to rapidly disconnect the circuit when a short-circuit fault occurs in the power battery module, preventing the aircraft from losing power due to a short-circuit fault in a single battery.

Preferably, when a fault or abnormality occurs in the circuit of the power battery pack, the current in the circuit increases. When the current reaches the melting threshold of the fuse (FU), the fuse (FU) automatically melts, disconnecting the circuit to protect the circuit components from damage caused by a short-circuit fault.

Preferably, each battery management unit collects and manages the data thereof respective power battery module and transmits the data, which includes voltage, current, temperature, State of Charge (SOC) status, and voltage difference.

Preferably, each battery management unit is equipped with three-channel CAN interfaces. A first-channel CAN interface (CAN1) is used for hardware debugging. A second-channel CAN interface (CAN2) is connected to the CAN2 network, forming an internal CAN network for the battery management system with the N sets of power battery modules of the aircraft. A third-channel CAN interface (CAN3) is used for communication with external devices and is connected to the complete ALLCAN network.

Preferably, among the M battery management units serving as backup communication main units, the priority of the backup communication main unit is determined based on the magnitude of battery management unit Identifications (IDs). The smaller the battery management unit ID is, the higher the priority of the battery management unit ID is. If a current communication main unit fails, a battery management unit ID with the smallest position among the M battery management units is selected as a new communication main unit to forward the data from the N sets of power battery modules connected in parallel to the complete ALLCAN network.

Here each battery management unit in the battery management system is capable of acting as a communication main unit. To avoid the probability of hardware failure and to ensure redundancy, part of the battery management units are selected as backup communication main units from all the battery management units. If the current communication main unit fails, the battery management unit ID with the smallest position among the M battery management units is selected as the new communication main unit. This ensures that the aircraft reliably acquires the battery data required for safe flight, enhances the reliability of the aircraft's power management, and guarantees flight safety.

Preferably, the power battery pack is composed of lithium-ion polymer cells.

Preferably, the pack housing of the power battery pack is reinforced with 1.0 mm-thick fire-resistant fiberglass plates and includes an internal temperature sensor. The power battery pack is installed inside the chassis of the aircraft with flexible mounting to avoid direct tensile and compressive forces on the battery group and to mitigate the impact of aircraft vibrations on the batteries.

A method of reserving backup communication main units, said method being used for selecting a backup communication main unit in a battery management system, includes the following steps:
S1. Setting a battery management unit ID in the battery management system;
S2. Using the magnitude of the battery management unit ID as a standard for setting the priority of the backup communication main unit, and the smaller the battery management unit ID is, the higher the priority of that battery management unit ID is;
S3. Confirming whether the current communication main unit in the battery management system has failed. If the current communication main unit failed, selecting the battery management unit ID with the smallest position, among the M battery management units, as a new communication main unit; and
S4. The new communication main unit forwards the data from the N sets of power battery modules connected in parallel to the complete ALLCAN network.

This application also proposes an aircraft equipped with the aforementioned battery management system with a plurality of backup communication main units.

Compared to prior art, the advantages of the present invention are as follows:

This invention proposes a battery management system and aircraft with a plurality of backup communication main units. The system includes several power battery modules, and each power battery module includes a battery management unit. The battery management system adopts a design with a plurality of backup communication main units and considers the probability of hardware failure and redundancy. Parts of the battery management units are selected as backup communication main units. Using the magnitude of the battery management unit ID as a standard for setting the priority of the backup communication main unit when reserving backup communication main units. The smaller the battery management unit ID is, the higher the priority of that battery management unit ID is. If the current communication main unit fails, the battery management unit ID with the smallest position is selected as a new communication main unit. This enhances the fault tolerance and reliability of aircraft communication, ensures reliable acquisition of battery data required for safe flight, improves the reliability of power management, and guarantees flight safety.

### BRIEF DESCRIPTION OF THE DRAWINGS

FIG. 1 is a schematic structural diagram of a structural connection of a battery management system with a plurality of backup communication main units proposed in Embodiment 1 of the present invention;

FIG. 2 is a schematic structural diagram of a structural connection of a single power battery pack proposed in Embodiment 1 of the present invention; and

FIG. 3 is a flow schematic diagram of the method of reserving backup communication main units proposed in Embodiment 2 of the present invention.

### DETAILED DESCRIPTION OF THE EMBODIMENTS

The accompanying drawings are provided for illustrative purposes only and should not be construed as limiting the scope of this patent.

To better illustrate embodiments, certain parts of the drawings may be omitted, enlarged or reduced in size, which does not represent the actual dimensions.

It is understandable that some well-known content in the drawings may be omitted for the sake of clarity to those skilled in the art.

Below is a further explanation of the technical solution of this invention in conjunction with the drawings and embodiments.

The descriptions of positional relationships in the drawings are for illustrative purposes only and should not be construed as limiting the scope of this patent.

### Embodiment 1

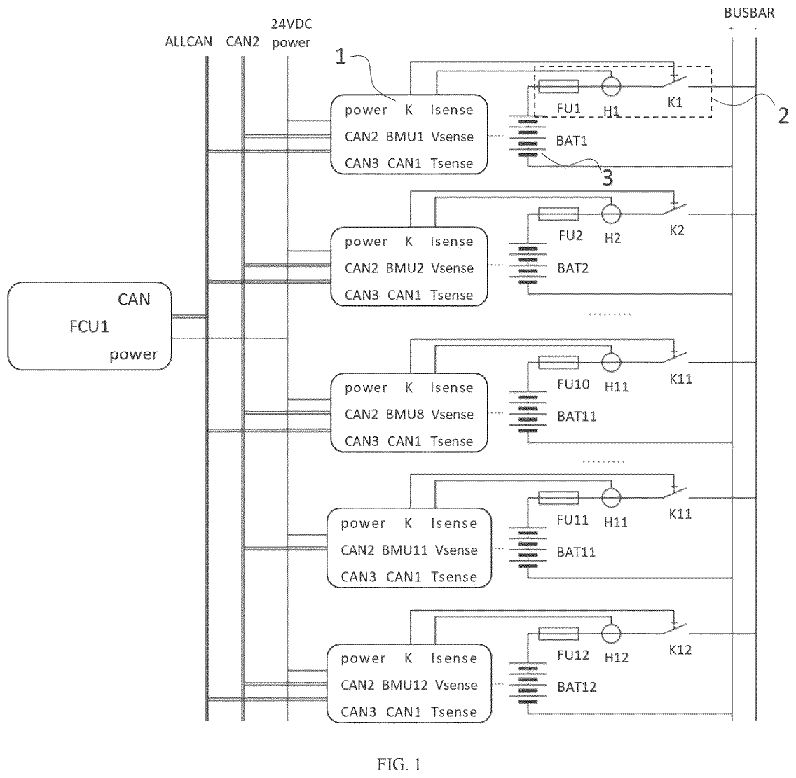

As shown in FIG. 1, this embodiment proposes a battery management system with a plurality of backup communication main units. In this embodiment, the battery management system includes 12 sets of parallel-connected power battery modules. Each set of power battery modules includes a battery management unit 1, a battery protection component 2, and a power battery pack 3. Among the 12 sets of parallel-connected power battery modules, there are 12 battery management units. These battery management units 1 are connected via a CAN network to monitor, collect data, and control communication for the 12 sets of power battery modules. Each battery management unit can theoretically serve as a communication main unit. However, considering the probability of hardware failure and redundancy, some battery management units are selected as backup communication main units among all of them. In this embodiment, 4 out of the 12 battery management units are selected as backup communication main units. Each backup communication main unit can forward data from the 12 sets of parallel-connected power battery modules to the complete ALLCAN network.

The proposed battery management system with a plurality of backup communication main units features multiple independent power battery modules, including battery protection components which are allowed to rapidly disconnect the circuit in case of a short-circuit fault in any module, preventing the aircraft from losing power due to a short-circuit fault in a single battery. Additionally, by adopting a design with multiple backup communication main units and considering hardware failure probability and redundancy, this system enhances the fault tolerance and reliability of aircraft communication. It ensures reliable acquisition of battery data required for safe flight, improves the reliability of power management, and guarantees flight safety.

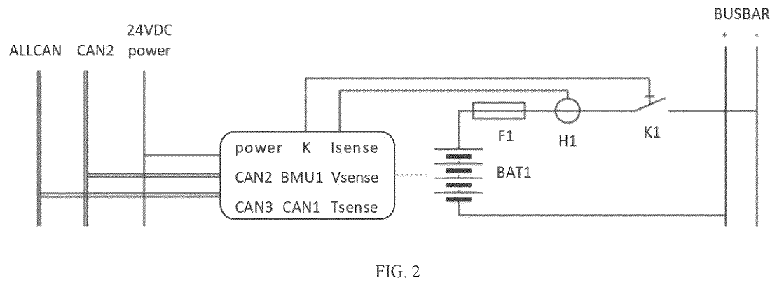

FIG. 2 illustrates the structural connection of a single power battery module. As shown in FIG. 2, the battery protection component 2 includes a fuse (FU), a Hall current sensor (H), and a relay (K). The relay (K) is an automatic switching device with isolation functionality. Referring to FIG. 1, in each power battery module, a negative terminal of the power battery pack 3 is connected to a positive busbar (BUSBAR+) of the aircraft. A positive terminal of the power battery pack 3 is connected to one end of the fuse (FU). The other end of the fuse (FU) passes through a central hole of the Hall current sensor (H) and is connected to a first contact of the relay (K). A second contact of the relay (K) is connected to a negative busbar (BUSBAR-) of the aircraft. A signal acquisition line of the Hall current sensor (H) is connected to the battery management unit 1 to enable real-time current detection. A coil terminal of the relay (K) is connected to the battery management unit 1. Referring to FIG. 2, it can be seen that the coil terminal of the relay (K) is connected to a “K” port of the battery management unit 1. Overall, the battery management unit 1, the battery protection component 2, and the power battery pack 3 form a circuit with the busbar of the aircraft. Based on received CAN communication commands, the battery management unit 1 issues control commands through the “K” port to switch the coil terminal of the relay on or off, thereby controlling whether the power battery module participates in the aircraft's charging or discharging state.

In practice, when a fault or abnormality occurs in the circuit of the power battery pack 3, the current in the circuit increases. When the current reaches the melting threshold of the fuse (FU), the fuse (FU) automatically melts, disconnecting the circuit. This protects the circuit components from damage caused by short-circuit faults.

Each battery management unit 1 collects and manages data from respective power battery module and transmits the data, which includes voltage, current, temperature, SOC status, and voltage difference. As shown in FIG. 1 and FIG. 2, the battery management unit 1 has “Vsense” and “Tsense” ports, which are used to monitor the state of the power battery pack.

As shown in FIG. 2, each battery management unit is equipped with three-channel CAN interfaces. A first-channel CAN interface (CAN1) is used for hardware debugging. A second-channel CAN interface (CAN2) connects to the CAN2 network, forming an internal CAN network for the battery management system with the 12 sets of power battery modules of the aircraft. A third-channel CAN interface (CAN3) is used for communication with external devices and connects to the complete ALLCAN network. In addition, as shown in FIG. 1 and FIG. 2, the battery management unit 1 also has a “power” port for connecting to a 24V DC power supply.

When selecting the communication main unit specifically, among the 4 battery management units serving as backup communication main units, the priority of the backup communication main unit is determined based on the magnitude of battery management unit IDs. The smaller the battery management unit ID is, the higher the priority is. If a current communication main unit fails, a battery management unit ID with the smallest position among the M battery management units is selected as the new communication main unit to forward the data from the N sets of parallel-connected power battery modules to the complete ALLCAN network.

As previously mentioned, each battery management unit in the battery management system can serve as a communication main unit. To avoid hardware failure probability and ensure redundancy, part of battery management units are selected as backup communication main units. If a current communication main unit fails, the battery management unit ID with the smallest position among the 4 battery management units is chosen as the new communication main unit. This ensures reliable acquisition of battery data required for safe flight, enhances the reliability of power management, and guarantees flight safety.

In this embodiment, the power battery pack is composed of lithium-ion polymer cells. The pack housing of the power battery pack is reinforced with 1.0 mm thick fire-resistant fiberglass plates and includes an internal temperature sensor. The battery pack is installed inside the chassis of the aircraft with flexible mounting to avoid direct tensile and compressive forces on the battery group and to mitigate the impact of aircraft vibrations on the batteries.

### Embodiment 2

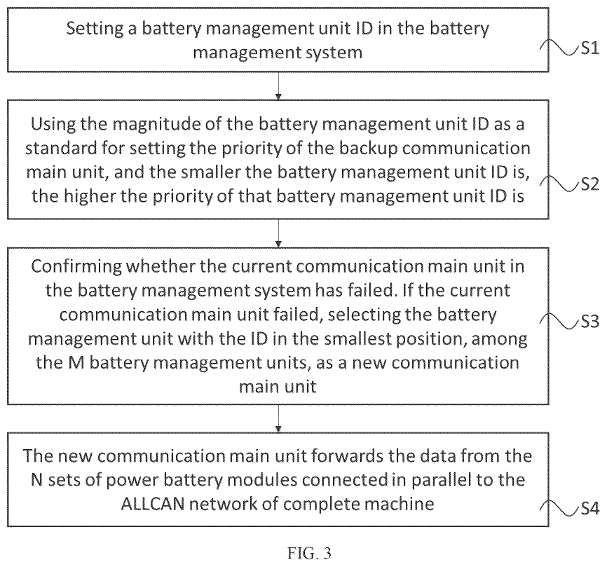

Referring to FIG. 3, this embodiment proposes a method of reserving backup communication main units, and said method being used for selecting a backup communication main unit in a battery management system includes the following steps:
S1. Setting a battery management unit ID in the battery management system;
S2. Using the magnitude of the battery management unit ID as a standard for setting the priority of the backup communication main unit, and the smaller the battery management unit ID is, the higher the priority of that battery management unit ID is;
S3. Confirming whether the current communication main unit in the battery management system has failed. If the current communication main unit failed, selecting the battery management unit ID with the smallest position, among the M battery management units, as a new communication main unit; and
S4. The new communication main unit forwards the data from the N sets of power battery modules connected in parallel to the complete ALLCAN network.

### Embodiment 3

This embodiment also proposes an aircraft equipped with the aforementioned battery management system with a plurality of backup communication main units. With such design, the aircraft features multiple independent power battery modules, each containing a battery protection unit that can quickly disconnect the current circuit of the battery module in case of a short-circuit fault. This prevents the aircraft from losing power due to a short-circuit fault in a single battery, thereby increasing the redundancy of the aircraft's power supply and enhancing the reliability of power management, ensuring flight safety. Compared to traditional aircraft power management systems, which rely on one single battery management unit as the main unit for communication with the flight controller, this design significantly improves system reliability. In traditional systems, a failure of the main unit would result in the loss of battery-related data, affecting flight safety. The multi-main unit backup design of the battery management system enhances fault tolerance and reliability in system communication, ensuring that the aircraft can reliably acquire the battery data required for safe flight.

Clearly, the above embodiments are provided merely as examples to illustrate the present invention. It is not intended to limit the scope of the implementation. It should be noted that for a person of ordinary skill in the art, various modifications and substitutions can be made based on the above description. It is not feasible or necessary to exhaustively list all possible implementations here. Any modifications, equivalent substitutions, and improvements made within the spirit and principles of this invention should be included within the scope of protection defined by the claims of this invention.

What is claimed is:

1. A battery management system having a plurality of backup communication main units, comprising N sets of power battery modules connected in parallel, wherein the N sets of power battery modules connected in parallel comprises N battery management units in total, and among the N battery management units, M battery management units serve as backup communication main units, where M<N, and each of the backup communication main units is configured to forward data from the N sets of power battery modules connected in parallel to a complete ALLCAN network.

2. The battery management system according to claim 1, wherein each power battery module of the N sets of power battery modules comprises a battery management unit, a battery protection component and a power battery pack, wherein the battery protection component comprises a fuse, a Hall current sensor and a relay; wherein within each power battery module, a negative terminal of the power battery pack is connected to a positive busbar of an aircraft, and a positive terminal of the power battery pack is connected to a first end of the fuse, and a second end of the fuse passes through a central hole of the Hall current sensor and is connected to a first contact of the relay, while a second contact of the relay is connected to a negative busbar of the aircraft; wherein a signal acquisition line of the Hall current sensor is connected to the battery management unit to enable real-time current detection; and a coil terminal of the relay is connected to the battery management unit, and the battery management unit controls connection and disconnection of the coil terminal of the relay based on received Controller Area Network (CAN) communication commands, thereby controlling whether the power battery module participates in the aircraft's charging and discharging state.

3. The battery management system according to claim 2, wherein, when a fault or abnormality occurs in a circuit of the power battery pack, a current in the circuit increases, and when the current reaches a melting threshold of the fuse, the fuse automatically melts, disconnecting the circuit.

4. The battery management system according to claim 2, wherein each battery management unit collects and manages the data thereof respective power battery module and transmits the data, wherein the data comprises voltage, current, temperature, State of Charge (SOC) status, and voltage difference.

5. The battery management system according to claim 4, wherein each battery management unit is equipped with a first-channel CAN interface, a second-channel CAN interface and a third-channel CAN interface, wherein the first-channel CAN interface is used for hardware debugging, wherein the second-channel CAN interface is connected to a CAN2 network, forming an internal CAN network for the battery management system with the N sets of power battery modules of the aircraft, and wherein the third-channel CAN interface is used for communication with external devices and is connected to the complete ALLCAN network.

6. The battery management system according to claim 1, wherein among the M battery management units serving as the backup communication main units, a priority of each of the backup communication main units is determined based on a magnitude of a battery management unit Identification (ID); wherein as the battery management unit ID decreases, the priority of the battery management unit ID increases; and when a current communication main unit fails, a battery management unit ID with a smallest position among the M battery management units is selected as a new communication main unit to forward the data from the N sets of power battery modules connected in parallel to the complete ALLCAN network.

7. The battery management system according to claim 1, wherein the power battery pack comprises lithium-ion polymer cells.

8. The battery management system according to claim 7, wherein a pack housing of the power battery pack is reinforced with 1.0 mm-thick fire-resistant fiberglass plates and comprises an internal temperature sensor, and the power battery pack is installed inside a chassis of the aircraft with flexible mounting.

9. A method of reserving backup communication main units, wherein the method being used for selecting a backup communication main unit in a battery management system, comprises the following steps:
S1: setting a battery management unit ID in the battery management system;
S2: using a magnitude of the battery management unit ID as a standard for setting a priority of the backup communication main unit, wherein as the battery management unit ID decreases, the priority of the battery management unit ID increases;
S3: confirming whether a current communication main unit in the battery management system has failed, and when the current communication main unit failed, selecting the battery management unit ID with a smallest position, among M battery management units, as a new communication main unit; and
S4: allowing the new communication main unit to forward the data from N sets of power battery modules connected in parallel to a complete ALLCAN network.

10. An aircraft, comprising the battery management system according to claim 1.

11. The aircraft according to claim 10, wherein in the battery management system, each power battery module of the N sets of power battery modules comprises a battery management unit, a battery protection component and a power battery pack, wherein the battery protection component comprises a fuse, a Hall current sensor and a relay; wherein within each power battery module, a negative terminal of the power battery pack is connected to a positive busbar of an aircraft, and a positive terminal of the power battery pack is connected to a first end of the fuse, and a second end of the fuse passes through a central hole of the Hall current sensor and is connected to a first contact of the relay, while a second contact of the relay is connected to a negative busbar of the aircraft; wherein a signal acquisition line of the Hall current sensor is connected to the battery management unit to enable real-time current detection; and a coil terminal of the relay is connected to the battery management unit, and the battery management unit controls connection and disconnection of the coil terminal of the relay based on received CAN communication commands, thereby controlling whether the power battery module participates in the aircraft's charging and discharging state.

12. The aircraft according to claim 11, wherein in the battery management system, when a fault or abnormality occurs in a circuit of the power battery pack, a current in the circuit increases, and when the current reaches a melting threshold of the fuse, the fuse automatically melts, disconnecting the circuit.

13. The aircraft according to claim 11, wherein in the battery management system, each battery management unit collects and manages the data thereof respective power battery module and transmits the data, wherein the data comprises voltage, current, temperature, SOC status, and voltage difference.

14. The aircraft according to claim 13, wherein in the battery management system, each battery management unit is equipped with a first-channel CAN interface, a second-channel CAN interface and a third-channel CAN interface, wherein the first-channel CAN interface is used for hardware debugging, wherein the second-channel CAN interface is connected to a CAN2 network, forming an internal CAN network for the battery management system with the N sets of power battery modules of the aircraft, and wherein the third-channel CAN interface is used for communication with external devices and is connected to the complete ALLCAN network.

15. The aircraft according to claim 10, wherein in the battery management system, among the M battery management units serving as the backup communication main units, a priority of each of the backup communication main units is determined based on a magnitude of a battery management unit ID; wherein as the battery management unit ID decreases, the priority of the battery management unit ID increases; and when a current communication main unit fails, a battery management unit ID with a smallest position among the M battery management units is selected as a new communication main unit to forward the data from the N sets of power battery modules connected in parallel to the complete ALLCAN network.

16. The aircraft according to claim 10, wherein in the battery management system, the power battery pack comprises lithium-ion polymer cells.

17. The aircraft according to claim 16, wherein in the battery management system, a pack housing of the power battery pack is reinforced with 1.0 mm-thick fire-resistant fiberglass plates and comprises an internal temperature sensor, and the power battery pack is installed inside a chassis of the aircraft with flexible mounting.
